(19) United States
(12) Patent Application Publication
(10) Pub. No.: US 2009/0164253 A1
(43) Pub. Date: Jun. 25, 2009

(54) Use of Mobile Communications Device to Direct Medical Workflow and as a Repository of Medical information

(76) Inventor: Hugh Lyshkow, Gleneden, OR (US)

Correspondence Address: Wendell Ray Guffey, 1510 William Lane, Swansea, IL, 62226, US

(21) Appl. No.: 12/084,155

(22) PCT Filed: Oct. 27, 2006
(86) PCT No.: PCT/US06/41983

§ 371 Date: Apr. 25, 2008

Related U.S. Application Data
(60) Provisional application No. 60/730,578, filed on Oct. 27, 2005.

(51) Int. Cl. G06Q 50/00; G06Q 10/00; G06F 15/16; G06F 17/30

(52) U.S. Cl. 705/3; 709/204; 707/104.1; 707/E17.044

(57) ABSTRACT

This invention comprises DICOM and/or HL7 based methods that enable a healthcare worker equipped with a smartphone with any form of Internet connectivity to securely direct the transfer of medical information from DICOM or HL7 compatible storage sites, including the user's own smartphone, to another DICOM/HL7 or non-DICOM compatible device where the information is wanted and needed. A method for securely transferring DICOM and/or HL7 data, by SMS reference, to another smartphone equipped with the software is also disclosed, as is transferal to non-DICOM or HL7 compliant devices by E-Mail or MMS message. This invention uses standard wireless communications and network protocols to expedite the flow of patient-information between physicians, wherever they are located, and repositories of needed patient information, e.g. PACS or HIS, thus improving healthcare and reducing healthcare costs. Finally, an individual can use this invention to store their Personal Health Record (PHR) on their smartphone and securely transport their PHR in its original DICOM or HL7 format.

### CROSS-REFERENCE TO RELATED APPLICATIONS

This application claims priority to PCT/US2006/041983 filed on Oct. 27 2006, which claims priority to U.S. Provisional Application Ser. No. 60/730,578 filed Oct. 27, 2005, the disclosures of which is incorporated herein by reference.

### BACKGROUND OF THE INVENTION

This invention relates to the use of computerized cell phones to implement a process of automatically locating, transferring and storing needed medical information as the information becomes available.

Cell phones equipped with microprocessors and associated Operating Systems, are often known as a smartphones. Digital Imaging and Communications in Medicine, version 3.0 (DICOM) is the American College of Radiology (ACR) and National Electrical Manufacturers Association (NEMA) sponsored worldwide standard used for securely communicating and storing medical images and other health related data while Health Level 7 (HL7) is the standard for non image-related medical data. Thus DICOM and HL7 compatible smartphones are useful for transferring medical information from one DICOM or HL7 compatible wireless communication device, to one or more other compatible, network-connected devices and for securely storing the transferred information. In this context the invention is useful for directing the secure electronic transfer of medical or other wanted information from one location where the information may be stored, to one or more other distant locations where the information can be conveniently used to enable a healthcare worker to carry out their professional work activities. Additionally, the invention enables a smartphone to be used as a repository of an individual's personal healthcare record (PHR). In this context the invention allows individuals to acquire their personal health record (PHR) on their smartphone thus enabling them to physically transport their PHR from place to place and to transfer the digital information to healthcare workers needing the information. In this way, the invention helps patients facilitate their own healthcare by always having their complete medical record available with themselves. The method is useful in the healthcare industry and for similar purposes in other specialized sectors of commerce.

A physician's or other healthcare worker's daily workflow generally involves the use of medical information including, but not limited to, radiology images such as those resulting from Magnetic Resonance (MR) Imagers, Computerized Tomography (CT), Positron Emission Tomography (PET), Ultrasound, X-Ray, and so on, as well as a wide variety of other clinically related images and laboratory tests and the reports which interpret these images and tests. These and many other needed items of medical information are often located and stored at sites distant from the location of the healthcare worker. For example, the healthcare worker might be located at a hospital or clinic in city X while a patient under supervision of the healthcare worker might be located at a hospital or clinic in city Y. Additionally, it is often the case that one healthcare worker is in possession of a patient's medical information that is wanted by one or more other distantly located healthcare workers where the distant sites might be hospitals, clinics, airports, trains, cars, restaurant, homes and so on. For example, a radiologist in one location may possess X-Ray images and reports describing those images that are wanted by a treating physician at a second location and by a physician at a third location who wants to provide a second opinion report of the same X-Ray. Moreover, it is also often the case that patients requiring medical treatment while located in city X need access to their PHR and its contained information but that the information is located at some distant site, e.g., city Y. In summary, it is very common occurrence for medical or other information to be located or stored at one site and for that information to be wanted by a multiplicity of other workers located at disparate distant sites.

It is also often the case that a physician's practice of medicine is most efficacious and of greatest benefit to the patient when the physician has unrestricted access to wanted information. Thus, it is of benefit to the patient and to the healthcare worker and to the healthcare worker's employer that, within the Health Insurance Portability and Accounting Act (HIPAA) guidelines, wanted information related to a patient's status be unrestrictedly available to the healthcare worker. For example, it is most beneficial to a patient with a tumor if the treating physician and all consulting physicians have unrestricted, HIPAA compliant, access to all of the radiology studies bearing on that patient's disease.

Moreover, further benefit accrues to the patient if the patient has available a copy of their PHR or ready access to a copy of their PHR at the time that they seek medical relief for a new or chronic disease state and if the patient can make that information available to all healthcare workers concerned with that patients state of health. For example, when a patient visits a physician for the first time regarding a new or chronic disease state, if all of the patient's medical records are available to the physician at the time of the patient's visit, it is much less likely that the patient will have to return to the physicians office or experience delayed treatment because needed medical information is unavailable. Likewise, if one healthcare worker possesses information on a patient's disease state and if that information is also needed by other members of the patient's healthcare team, it is to the benefit of the patient that the information be made available to the entire healthcare team in a HIPAA compliant way. Likewise, if one healthcare worker needs information related to a patients health and if that information is distantly located, it is also of benefit to the patient and the physician if the physician can gain unrestricted, HIPAA compliant access to that information. Finally, if a physician is away from his/her work site, for example at an airport, at home or in a restaurant, and if that physician has access to a patients healthcare information which is wanted by other healthcare workers, but which is unavailable to those workers, then it is again of benefit to the patient and the healthcare team to securely make that information available to all members of the team in a HIPAA compliant manner.

However, these scenarios that maximize the benefit of the healthcare system to the patient are often not achieved in daily practice because patients are mobile, relocating and traveling from city to city and country to country, and physicians are also highly mobile, traveling between home, meetings, and various offices, clinics, or hospitals. Thus, it is often the case that physicians, their patients, and their patient's medical records are not in convenient physical proximity so that needed information is not readily available when needed. The unwanted consequence of these happenings are that patient treatments are often delayed, physicians' work performance is inefficient, and costs to the healthcare system soar as patients and physicians travel from site to site to gain access to needed information or to physically transport that information from site to site as well as the need to replicate procedures and tests due to the unavailability of previous results.

In recent years this problem has been in-part alleviated by the use of wired phones and cell phones for voice communication and the growing accessibility of information via the Internet using personal computers (PCs). Thus, physicians with access to a wired or wireless phone can often efficiently get or give wanted information verbally and, if they have access to an appropriately configured desktop computer or workstation or other such device, they can often efficiently access and transfer wanted digital information, such as medical images or reports needed to effectively treat their patients, regardless of how distantly located the information, the patient, and the physician are from one another. Additionally, the concept of a digital PHR is gaining dominance in the healthcare enterprise and computer based methods of porting a patient's medical record are proliferating. These methods include the use of computers to electronically port information over networks, including the Internet, and the use of portable devices such as PDAs and portable media, including Flash RAM and magnetic and optical disks. However, it is still often the case that a physician needing patient information is not at the site where the information is available and does not have access to a PC, and that the information needed, such as a medical image, is not amenable to verbal phone communication. Additionally, even if an appropriate computer is available to the physician, it may be that this computer will not be configured in a manner that allows the wanted information to be made available. For example, it is likely that wanted patient information, that is physically available on a network, will be encoded according to the DICOM, HL7 or other medical standard but that the available computer will not be configured to access the standard based information and, consequently, will be unable to access or interpret the securely encoded DICOM or HL7 information. Thus, even with the availability of information via the Internet, there are often situations when a healthcare practitioner needs patient information which is located at a distant site but the information cannot be accessed because no method exists for accessing the data from the physician's current location. Aside from the inconvenience of this situation to patients, it may also be detrimental to the patient's health. Likewise, these situations may require the physician to travel to a site where wanted information is available, thus taking up valuable professional time in travel and delaying the patient's diagnosis and/or therapy.

The recent introduction of wireless broadband data transfer services, known as 2.5G, 3G and developing next generation services, along with the availability of hybrid hardware devices having the combined technical features of a computer and a wireless telephone communication device have facilitated the rapidly growing practice of receiving and transmitting complex information between many remote locations and centralized repositories of information. However transfer and storage of medical information is stringently regulated by HIPAA and thus physicians desiring to use smartphones to obtain and transmit medical information require special secure transmission devices and facilities to obtain transmit and store sensitive medical information. Such information is often crucial for initiating events such as providing healthcare to an ailing patient. These special smartphone security enabling aids are generally not available today.

In addition recent advances in wireless computer connectivity known as Wi-Fi, WiMax, and Bluetooth, as well as other newly emerging connectivity protocols have provided smartphones with the ability to communicate via the Internet with other connected devices, such as but not limited to, Picture Archiving and Communications Systems (PACS), Radiology Information Systems (RIS), or Hospital Information Systems (HIS). Moreover, using the Short Message Service (SMS) protocols and Multimedia Messaging Services (MMS), as well as other forms of E-Mail, hybrid mobile devices can function in a limited way to transmit and obtain patient information although the information available by these processes may often not be secure to the extent required by the Federal Health Insurance Portability and Accounting Act (HIPAA) and other laws and regulations that govern the use and transmission of a patients medical information.

### SUMMARY OF THE INVENTION

It is, therefore, an object of the present invention to provide hybrid, handheld communications devices, generically known as “smartphones” with the software based capability, known as Peer Director, to securely direct the transfer of DICOM and HL7 encoded, and other compatible medical information, between the smartphone and any medical standards-compatible computer server, laptop PC, desktop PC, PDA, Tablet PC, or other compatible smartphone using wireless transmissions linked to the Internet and connected networks. The principal novel feature of the invention is that it allows a smartphone equipped healthcare user, located anywhere within range of a wireless cell phone tower, or of an Internet coupled Wi-Fi/WiMax or Bluetooth node, to direct the transfer of medical information from one DICOM or HL7 compatible storage site, including the user's own smartphone, to any one or more other DICOM or HL7 compatible sites where the information is wanted and needed, including the user's own smartphone or another smartphone device.

It is another object of the invention to provide healthcare workers with a smartphone having the capability of accessing secure medical data to which they have legal rights and to store that data in a secure HIPAA compliant way to their personal smartphone. For healthcare workers, the medical data stored on smartphones may consists of images, reports and other work related information that the healthcare worker can carry with themselves and review at an opportune time or which they can transfer to permanent storage at a fixed location at an opportune time. In these ways, smartphones can act as a storage media and as a processing device that facilitates secure HIPAA compliant transfer of medical information.

A third objective of this invention is to provide individuals with applications that will enable their personal smartphone to securely obtain, store and transfer their electronic personal healthcare record (PHR) and to physically carry their PHR with them wherever and whenever they travel.

These and other objectives, illustrated in the appended figures, are achieved using smartphones securely connected via a network to remote medical data-containing servers including, but not limited to, those known as PACS, HIS, RIS, or other devices utilizing the DICOM and/or HL7 transmission protocols where patient related medical information is collected and stored. Additionally, the smartphone may be connected via the network to other smartphones which also contain secure medical data. In all cases security protocols restrict access to personal medical data to healthcare professionals who are authorized to access the data or who otherwise have a legal right to the data as mandated by HIPAA and other laws or regulations that govern the privacy and security of personal health information.

Other and further objects, features and advantages of the present invention will be readily apparent to those skilled in the art.

### DESCRIPTION OF THE DRAWINGS

FIG. 1 illustrates the secure pathways and available hardware that are employed by this invention to provide secure wireless connectivity between medical smartphone users and repositories of needed medical information.

FIG. 2 illustrates data movement from a remote DICOM device to a mobile device or smartphone. This diagram shows the different communication layers that underlie information transfer between the mobile phone and the DICOM device. The underlying hardware layer is transparent to the devices, as all communications use the DICOM protocol to communicate over a Transmission Control Protocol/Internet Protocol (TCP/IP) network. Similar HL7 encoded information transfer is envisaged.

FIG. 3 illustrates the use of a wireless mobile device, or smartphone, as a medical data repository and as a director of information transfer. The mobile phone (100) initiates a transfer (306) of DICOM (or HL7) files from the remote DICOM device (120) after querying (304) the remote DICOM device. DICOM files (308) are stored to the mobile phone memory (310), hard disk (314) (if present), or removable memory card (312) (if present).

FIG. 4 illustrates information transfer directed by a smartphone equipped with the Peer Director software application from one distantly located DICOM or HL7 compatible device to a second HL7 or DICOM compatible device. The DICOM and HL7 standards support the retrieval of their respective files which can be directed to another DICOM or HL7 device (120-B), allowing the mobile phone (100) to act as the initiator of the action (402), i.e. as a remote control. Both the device (120-A) that transmits, and (120-B) the device that stores the files (408) must be configured to recognize each other and a network connection (300) must be present between the two remote DICOM devices.

FIG. 5 illustrates the movement (500) of DICOM files stored on a smartphone (100) to a remote DICOM device (120) for storage (408). Similar HL7 file transfer is envisaged.

FIG. 6 illustrates the use of a Peer Director equipped smartphone acting as an intermediary in transfer of information between two DICOM or HL7 compatible devices that have not been configured to recognize one another or are not physically connected. If the remote DICOM or HL7 device (120-A) storing the files is not aware of the second DICOM or HL7 device (120-B), the smartphone (100) can act as the intermediary, where files are retrieved (304) first to the phone (100) and then sent (500) to the second DICOM device (120-B), with the files (600) being deleted from the smartphone as the second DICOM or HL7 device reports that each file (408) has been successfully received.

FIG. 7 illustrates the Peer Director mediated secure transfer and storage of information from its location on a smartphone to a permanent storage site on a remote DICOM or HL7 device. When it is critical that medical standard encoded files (704) be successfully stored (500) to a remote DICOM or HL7 device (120), it is possible to ask the remote device (120) to confirm successful receipt of the encoded files (704) and it will “take responsibility” for their archiving. In the DICOM standard this is done via the DICOM Storage Commitment request (700). Once a remote DICOM device (120) acknowledges the receipt of the files specified in the Storage Commitment request, the smartphone (100) can then safely delete the DICOM files from smartphone storage. The remote DICOM device may also respond that it has failed to store the files (702) or that it does not wish to take permanent responsibility for archiving the files.

FIG. 8 illustrates the acquisition of data by a Peer Director equipped smartphone and the transmission of that data to a non-DICOM compliant remote device using E-Mail. To forward DICOM or HL7 files to a device that is not medical standards compatible (808), it is possible to first query (304) and retrieve (306) the DICOM or HL7 encoded files (308) from the Remote DICOM device (120) to the mobile phone (100), then convert (800) the DICOM or HL7 encoded files into a multipurpose internet mail extension (MIME) encoded E-Mail message (802), and then use the mobile phone's E-Mail capabilities to send (804) the E-Mail to the third party, who will then retrieve (810) the E-Mail message using their E-Mail client. E-Mail from the mobile device is transmitted to an intermediate SMTP Server (806) or other form of corporate E-Mail Server, and is retrieved from the Mail Server by the remote device with E-Mail access.

FIG. 9 illustrates the SMS triggered transfer of information by a Peer Director equipped and SMS capable wireless communication device to a distant Peer Director equipped smartphone. For every worklist item within the smartphone or DICOM or HL7 files retrieved to the smartphone, a reference is stored identifying the origin of the file, i.e. the remote device that originated the standards encoded data. When data is to be sent from one Smartphone (100-B) to another Smartphone user (100-A) also working with the Peer program, an SMS message (900) is used to inform the remote mobile phone where the DICOM or HL7 data can be retrieved from, e.g. from a PACS (120) in the case of this DICOM based example. This SMS message will trigger a C-GET operation (304) such that the DICOM files (308) are stored on the remote Smartphone (100-A) receiving the SMS message.

FIG. 10 illustrates the transmission of MIME encoded DICOM or HL7 files into an MMS message sent to another cell phone directly using the MMS services of both cell phones' cellular service providers. The MMS service allows multimedia messages to be sent between smartphones and cellular devices irrespective of the remote receiving device having Peer software installed. By MIME encoding (1002) the DICOM or HL7 files (308) on the originating smartphone (100-A), they can be transmitted (1306) to the remote cell phone (100-B) and arrive as an MMS message (1308). This transfer utilizes the MMS Standard which is supported by the cellular service providers of both devices, and utilizes the secure encrypted cellular network (1000) of the cellular services providers so does not require DICOM or HL7 level security.

FIG. 11 illustrates the User Interface (UI) storage screen showing the sequence of menu options available to transfer information residing on a Peer Director equipped smartphone to any other device. Stored DICOM or HL7 files can be transferred from the Storage component (1100) of the Peer application to other locations by selecting and highlighting a patient from the list, e.g., (1102). Subsequent activation of the Properties command (1104) opens a menu allowing the user to choose actions e.g., the “Send” action [1106]. In this case a sub-menu will be displayed [1108] allowing the manner by which the selection will be transmitted to be chosen.

### DETAILED DESCRIPTION OF THE INVENTION

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the preferred methods, devices, and materials are described herein.

All patents, patent applications, and publications mentioned herein are incorporated herein by reference to the extent allowed by law for the purpose of describing and disclosing the devices and methodologies reported therein that might be used with the present invention. However, nothing herein is to be construed as an admission that the invention is not entitled to antedate such disclosure by virtue of prior invention.

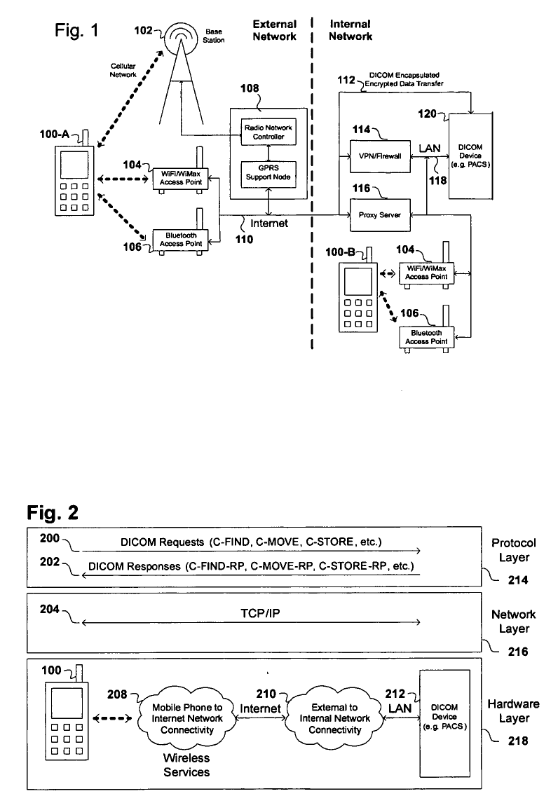

In one aspect, the present invention provides a secure system for finding wanted medical information and securely directing the flow of that information between one or a multiplicity of at least two remotely located Digital Imaging and Communications in Medicine (DICOM) or Health Level 7 (HL7) compatible devices. The hardware components of the system are comprised of commercially available devices including, but not limited to, one or more network connected mobile communications devices, known as smartphones, and/or fixed personal computers and/or one or more network connected, HL7 or DICOM-based servers each equipped with an operating system capable of accepting user programmed instruction. The system employs smartphone based algorithms that direct processes which can securely find and transfer needed information between compatible devices that possess the information and those devices that want the information. In one embodiment, the present invention provides a system by which wanted medical information is securely located and transferred between network connected hardware devices as directed by software algorithms written to the DICOM 3.0 standard using any of the available communications pathways illustrated in FIG. 1. The hardware employed in this invention consists of any commercially available broadband capable computing device, but preferentially it employs a smartphone or network of smartphones. As FIG. 1 also illustrates, smartphones (100-A and 100-B) can be connected to the Internet through a series of worldwide wireless services or optionally via standard Bluetooth (106), IrDa, Wi-Fi, and WiMax (104) services and thereby to medical local area networks (LANs), wide area networks (WANs) or wireless area networks (WLANs) and ultimately to their DICOM and/or HL7 based PACS, HIS, RIS, Laboratory Information System (LIS), Cardiology Information System (CIS) (exemplified by 120), and other computer servers, as well as to other smartphones where wanted medical information may be found as stored data or where data needs to be sent and securely stored.

In addition, it is generally well known to residents of the United States that the Health Insurance Portability and Accountability Act (HIPAA), signed into law by President Clinton on Aug. 21, 1996 (Pub. L. 104-191, 110 Stat. 1936) protects the privacy of personal medical information and mandates that personal medical information of all types be stored and transmitted in a secure manner so as to ensure the privacy and security of the healthcare information. Thus this invention employs a variety of security providing protocols that are also well known and generally employed in digital information transfer using wireless devices such as smartphones and via the Internet and Internet-connected devices. These security provisions are also illustrated in FIG. 1: DICOM security (112) is the capability for secure transmission utilized by devices conforming to the DICOM Standard (or alternatively the HL7 standard) and universally recognized to facilitate secure storage and transfer of authentic/original, digital medical images and reports. Virtual Private Networks (VPN) (114) are widely employed to transfer encrypted information between precisely identified computers or servers containing protocols known generally as firewalls. Proxy servers (116) are often used to act as trusted intermediaries between remote devices such as Web browsers and networks inside a hospital environment. All data communication between the remote devices and the proxy server are encrypted, and since the proxy server is inside the hospital's security system, the proxy server can thus act as a gateway for communications between the remote smartphone and hospital local area networks (LAN). These server devices possess filters and other such features that ensure the security of the information contained within the PACS itself or which might be transiently stored in the proxy server. Finally, within a secure LAN environment, Bluetooth Access Points (1D) and Wi-Fi/WiMax routers (1E) with their native HIPAA-compliant security protocols (e.g., Wi-Fi Protected Access (WPA), Extensible Authentication Protocols (EAP) and Wi-Fi Protected Access 2 (WPA2)), enable secure Bluetooth and Wi-Fi transmissions within a hospital environment. Outside the secure environment of a LAN, Wi-Fi/WiMax and Bluetooth connectivity (104 and 106 respectively) employs security provisions 112, 114, 116 shown in FIG. 1. The Internet data transfer component (110) of the system employs the universal TCP/IP standard for Internet communications. The application of these Internet based pathways and protocols are generally well known by software engineers and they are now widely employed by the general populace in Internet-connected, information transfer.

The principal smartphone software component of this invention is known as Peer Director. The main User Interface (UI) of the Peer software facilitates the ability of the healthcare worker or other user to find, retrieve, disseminate and store wanted information at the user's discretion. The system is especially useful for directing the automated transfer of DICOM encoded information between DICOM or HL7 compatible devices, that contain stored DICOM or HL7 information and DICOM or HL7 compatible devices that want the stored information. Repositories that might contain wanted information medical information include Smartphones, Picture Archiving and Communication Systems (PACS), medical scanners such as Magnetic Resonance (MR) Imagers, or Computerized Tomography (CT) Scanners, or other DICOM compatible devices and repositories of patient related information such as RIS, LIS, CIS or HIS. The algorithms that underlie the processes of this information-directing invention function within the context of a variety of wireless phone operating systems (OS) including, but not limited to, the Symbian OS, Palm OS, Windows Mobile 5.0 OS and the Java based OS deployed on Blackberry mobile communication devices that are produced by Research In Motion (RIM) and other Java based devices. Likewise, since the information finding and directing process is designed to be compatible with the latter multiplicity of operating systems, mobile phones and similar communications devices employing these operating systems will successfully perform the alerting and associated algorithms that are the basis of this invention.

The smartphones depicted in FIG. 1 (100) are those commercially available, mobile communicating devices designed for broadband data transfer and for use with an Operating System (OS) to which software applications and user instructions can be added. When these smartphones or other devices are equipped with the Peer Medical Inc. Peer software applications provided by this invention, they are capable of supporting digitally based processes that securely find, transfer and store DICOM, HL7 and other information which is the principal object of this invention. Operating systems for a wide range of such smartphones are commercially available worldwide. The smartphones and the OS's under which they function include, but are not limited to, Nokia's Series 60, 80, and UIQ based devices operating under the Symbian OS, the Palm smartphones operating under Palm OS, Blackberry mobile devices operating under a C++ or Java OS, Nokia Series 40 smartphones operating under a Java based OS, Windows PocketPC 2003 Smartphone edition, Windows Mobile 5.0 for Smartphones, QualComm's BREW based smartphones, and a wide variety of Linux based smartphones using the Mobilinux, QTopia or other Linux based embedded architectures.

As indicated earlier the infrastructure used to connect smartphones to the Internet includes, but is not limited to, conventional mobile phone cellular services, broadband wireless access including the Wi-Fi variants of the IEEE 802.11a, g, n, and WiMax IEEE 802.16 standards, Bluetooth or IrDa protocols. In smartphones equipped to operate via the latter named services, protocols, and standards electronic sensing circuits detect the availability of the services while software or ROM based algorithms within the smartphone verify the security of service and allow the user to select the fastest or most secure pathway to the Internet. In the present invention, software algorithms monitor the available connectivity pathway and automatically select the most appropriate Internet connection with primary emphasis on the security and safety of the available connections. Safety issues related to cellular devices are important because cellular based data transmission and voice communication have been implicated in interfering with sensitive medical devices found in some medical facilities, such as hospitals.

Thus, within a healthcare facility or any other facility equipped with a LAN, WAN, WLAN and Bluetooth or IrDa access point connectivity, connection to the Internet is preferentially via Bluetooth due to its point-to-point short distance signal nature; internal WLAN-based Wi-Fi would be the next most secure option due to its Wireless LAN encryption and user authentication protocols. In a public or commercial environment such as an airport, restaurant or any other location where direct point-to-point Bluetooth, IrDa, tethered or cradle-based connectivity is unavailable but Wi-Fi/WiMax connectivity is available connection is by Wi-Fi/WiMax. In remote environments not served by Bluetooth or IrDa access points or Wi-Fi/WiMax services or, in the case of smartphones that are not equipped to utilize available Bluetooth, IrDa, or Wi-Fi/WiMax services, connectivity to the Internet will be by wireless broadband services.

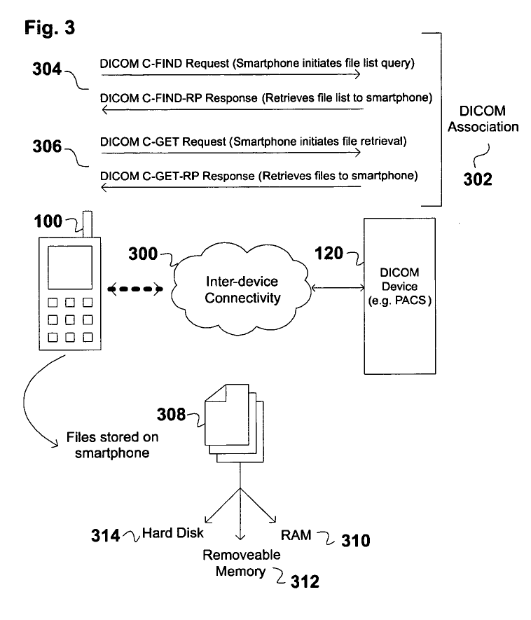

FIG. 2 illustrates the use of the widely recognized DICOM 3.0 standard-actions used for communication between two or more DICOM compliant devices. The actions known as DICOM request (200) and DICOM response (202) are shown in the context of the International Standards Organization's (ISO) Open Systems Interconnection (OSI) 7 layers Protocol Suite (for clarity only the protocol layer (214), the network layer (216) and the hardware layer (218) are shown). These standard DICOM actions define how computerized devices interact and exchange secure data, images and other information. In this invention the Application Layer, also known as the Protocol Layer (214) is used to transfer DICOM-based requests for information and their corresponding responses between communication devices. The network transport layer known as TCP/IP (216) represents the universally employed Transmission Control Protocol (TCP) and Internet Protocol (IP) that, respectively, define the transport and network layers used to transfer information over the Internet. All of the above are independent of the Hardware or Physical Layer (2E) that physically transmits, carries and receives the data packets encoded by the DICOM software and thus the DICOM actions are compatible with and can be employed by all computerized/Internet connected hardware devices. Finally, since smartphones (100) operate under an evolving series of standard service protocols, the Peer Director information transfer processes and their underlying algorithms, which form the core of this invention, are designed to be compatible with a variety of service protocols including, but not limited to, the original wireless protocol known as Global System for Mobile Communications (GSM) as well as other services that include, but again are not limited to, the GSM based General Packet Radio Services (GPRS), X25, a wireless service used mainly in Europe, and the more sophisticated services known as Enhanced Data rates for GSM Evolution (EDGE), Universal Mobile Telecommunications System (UMTS), wide-band CDMA (Code-Division Multiple Access), and high-speed downlink packet access (HSDPA). In the network environment, the medical data is transmitted via the secure DICOM 3.0 service elements that support the DICOM service classes Query/Retrieve, Verification, Storage, Modality Worklist, Modality Performed Procedure Step, Media Storage, and other DICOM network and media specific Service Classes. DICOM Message Service Elements (DIMSEs), which are components of the DICOM 3.0 Standard and are well known to practitioners of the art, are employed to direct the processes embodied in this invention. The use of the DIMSEs C-FIND and C-GET, are illustrated in FIG. 3 which shows a smartphone equipped with Peer Director (100) initiating a C-FIND (304) command over the Internet in order to identify needed information located on a second DICOM device (120) with subsequent use of the Internet communicated command C-GET (306) to retrieve those files to the smartphone where they can be stored in RAM (310), a hard drive (314) or removable memory (312). All of these standard methods of secure communication over wireless networks and the Internet are well know to practitioners of the art. Similar considerations exist for HL7 based information transfer protocols.

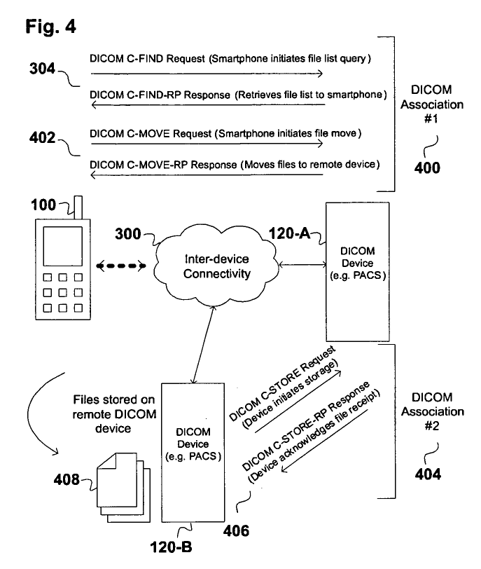

Likewise, FIG. 4 illustrates smartphone (100) based Peer Director software being employed to invoke a C-FIND (304) over the network to locate wanted, DICOM encoded information stored on a remote DICOM device (120-A) and to use the DIMSE C-MOVE service element (402) to disseminate by a C-STORE (406) the information over the network to a new DICOM device (120-B) configured to recognize and communicate with the first DICOM device (120-A). Not shown is the additional process in which a C-MOVE can be employed to disseminate found information to a multiplicity of other remote DICOM devices that have been configured to recognize and communicate with the first DICOM device (120-A). Also not shown are the equivalent HL7 based processes and enabling syntax.

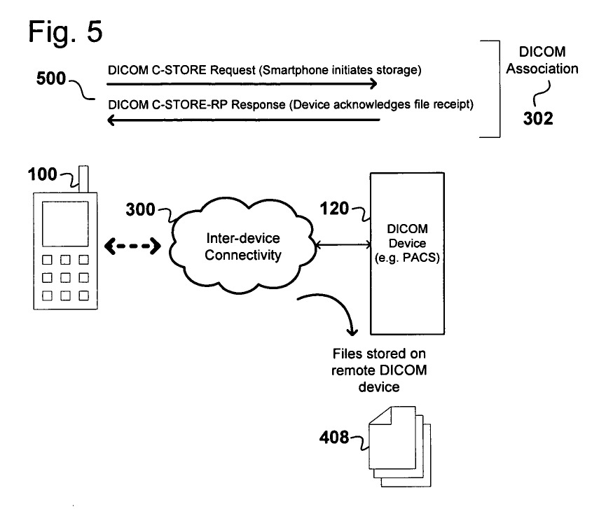

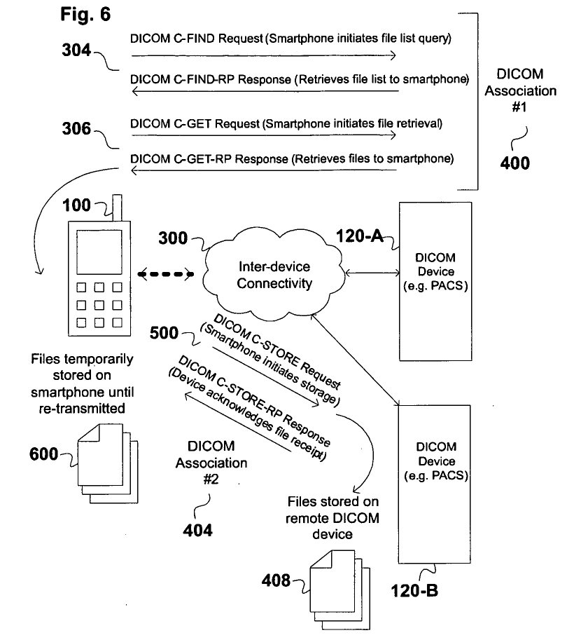

In some instances, medical information may happen to be stored on a smartphone and that information may be needed by users at a remote site, or a remote site may be the permanent repository of the information. For example, a healthcare worker might use the camera function of a smartphone shown in FIG. 5 (100) to record a picture of a patient's wound or rash or other physical feature that might characterize a disease state, or the healthcare worker might write and store a medical report on his/her personal smartphone. Such information can be sent to any of a multiplicity of DICOM compatible devices (e.g., 120) using the Peer Director software application, enabled on the smartphone (100), by invoking the DIMSE command C-STORE (500) which then functions to direct the information over the network to the site (120) or sites wanting the information and storing the information (408) at that location.

In other instances, it may occur that a smartphone user's device will be configured to communicate with a multiplicity of other remote DICOM devices (e.g., (120-A) and (120-B) of FIG. 6), which are configured to recognize and communicate with each other. In this case, FIG. 6 illustrates that it is still possible for a Peer Director equipped smartphone to effect transfer of information between 120-A and 120-B. In this instance, the smartphone (100) equipped with Peer Director software initiates the C-FIND (304) and C-GET (306) commands to locate and acquire wanted information from one of the remote DICOM devices, e.g., (120-A) and temporarily store the wanted information on the smartphone (100). Subsequently, Peer Director software on the smartphone moves the information to another appropriate DICOM device e.g., (120-B) using the DIMSE command C-STORE (500). In this scenario, the smartphone acts an intermediary in the movement of information and, when the destination site reports that the information has been successfully received, the information (600) temporarily stored on the smartphone is deleted. Similar information transfers can be made using equivalent HL7 encoded processes.

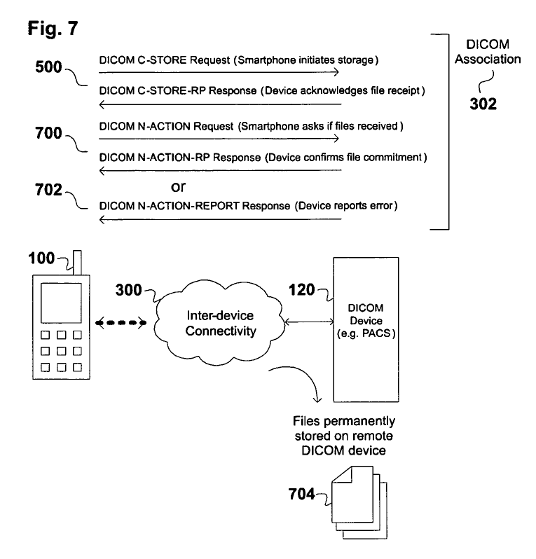

In some cases of data transmission, it is possible for medical and other information to be sent from one DICOM or HL7 compliant communicating device to a second remote DICOM or HL7 device but, because of communications interruptions or other causes, the unwanted possibility exists that information will not reach the intended receiving device. Because of this possibility, it is often important to request that the remote storage device confirm acquisition and storage of the sent information. FIG. 7 illustrates that a healthcare worker can assure the successful receipt and storage of sent information by employing Peer Director on their smartphone (100), to invoke the C-STORE command (500) plus the DICOM service command “DICOM Storage Commitment” (700). The DICOM Storage Commitment service shifts the responsibility for maintaining and storing the images from the sender's smartphone, or other sending modality, to a compatible DICOM storage site such as a PACS exemplified in FIG. 7 by device 120, and instructs the remote storage site to confirm that it has successfully received and accepts responsibility for the received DICOM encoded information (704), thus allowing the information to be removed from the relatively limited smartphone storage facility.

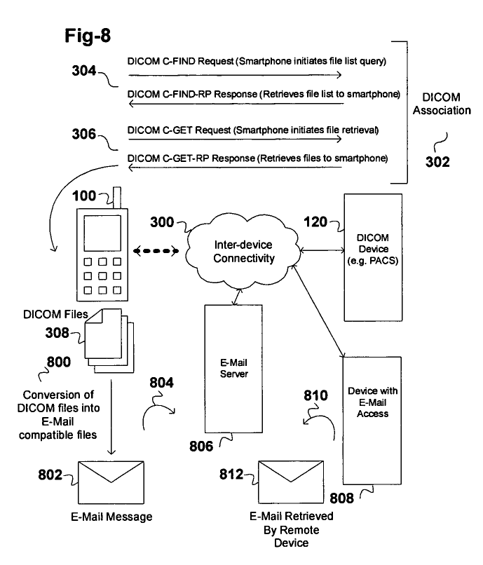

Peer Director also possesses the flexibility to communicate secure information stored on a smartphone (as illustrated in FIGS. 3, 5 and 6) to non-DICOM compliant devices. FIG. 8 illustrates this process whereby Peer Director software on smartphone (100) invokes C-FIND (304) and C-GET (306) actions to securely Query/Retrieve information from a remote DICOM compliant device (120). When the information is acquired, Peer Director processes can send the smartphone localized information to non-DICOM compliant devices (exemplified in FIG. 8 as (808)) by employing the DICOM protocol type known as DICOM Multipurpose Internet Mail Extension (DICOM MIME Type) (800) which defines how to attach or encapsulate DICOM encoded or other non-verbal, multimedia information into E-Mail (802) which can then be sent to the E-Mail service of any non-DICOM device via a Simple Mail Transfer Protocol (SMTP) server (806) and downloaded (812) to a non-DICOM server (808) or other compatible non-DICOM device using standard Post Office Protocol (POP) services (810).

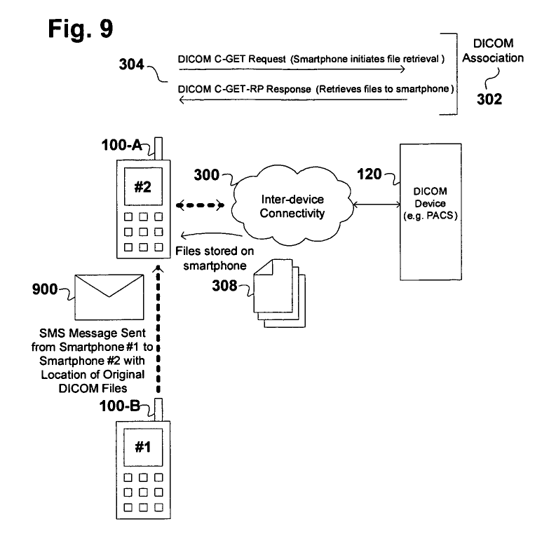

As shown in FIG. 9 it is also possible for a healthcare worker having a smartphone (100-B) equipped with Peer Director software to use the alphanumeric Short Message Service (SMS) (900) supported by the Global System for Mobile (GSM) communications, to transmit the location of wanted information to a second Peer Director equipped smartphone (100-A) with the Peer Director application on 100-A subsequently invoking the necessary DICOM commands to Query/Retrieve wanted DICOM encoded information from the specified storage site such as the DICOM device (120) to storage on the smartphone (100-A).

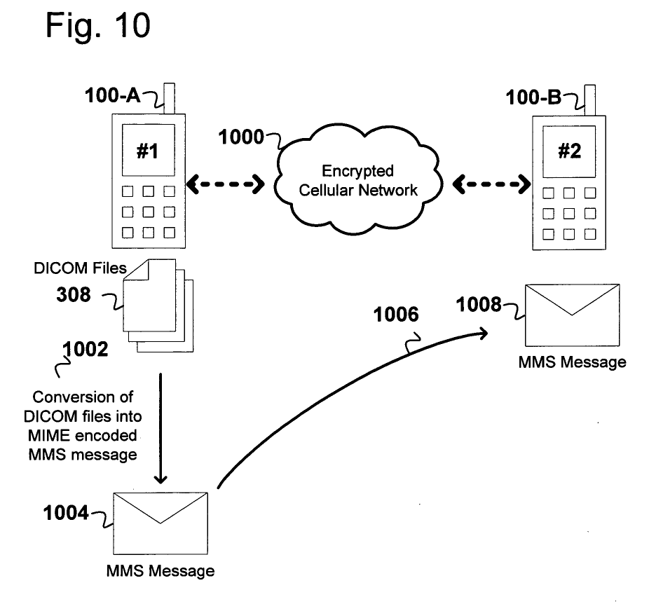

FIG. 10 shows that when transferring files from one smartphone (100-A) with Peer Director software to another cell phone (100-B) that does not have Peer Director, but with both devices having MMS service capabilities, that the DICOM files (308) can be encoded into an MMS message (1002), where the message (1004) will be transmitted (1006) to the remote cell phone using the secure encrypted network (1000) provided by the cellular network providers of the two cellular carriers, arriving at the remote device (100-B) as a standard MMS message (1008).

In all of the instances where information is transferred from one information possessing device to a second device (illustrated in FIGS. 1 through FIG. 11) the healthcare or other user will initiate the DICOM, HL7 or other action using software wizards which are more precisely known as dialog driven User Interfaces (UI). These algorithms, or wizards, that help direct a user's workflow on the device in a dialog based manner, are important components of this invention. These wizards enable the smartphone user to either construct worklists (lists of scheduled tasks and events) or construct queries that search remote DICOM or HL7 devices and return worklist items that comprise the user's daily work activities or other information that the healthcare worker needs to accomplish their work tasks in an efficient and timely manner. For example, radiologists need to acquire radiology images, analyze the image and report their findings on a patient's MR, CT, Angiogram, or X-Ray as soon as possible after an imaging procedure has been performed. Thus, when the healthcare user is informed of, or alerted to, the existence of these kinds of work related items of information, the Peer Director wizard enables the user to find and acquire the related and needed information to their smartphone and to direct information residing on their smartphone to other compatible devices as needed. Algorithms that underlie these processes will be written in the programming language specific to the OS employed by the smartphone. For example Symbian C++ for Series 60, 80, and UIQ based devices, or Java for Blackberry based devices. Additionally, the algorithms will be compiled to operate on all handheld communications devices that provide compatible connectivity, memory and OS support for these algorithms.

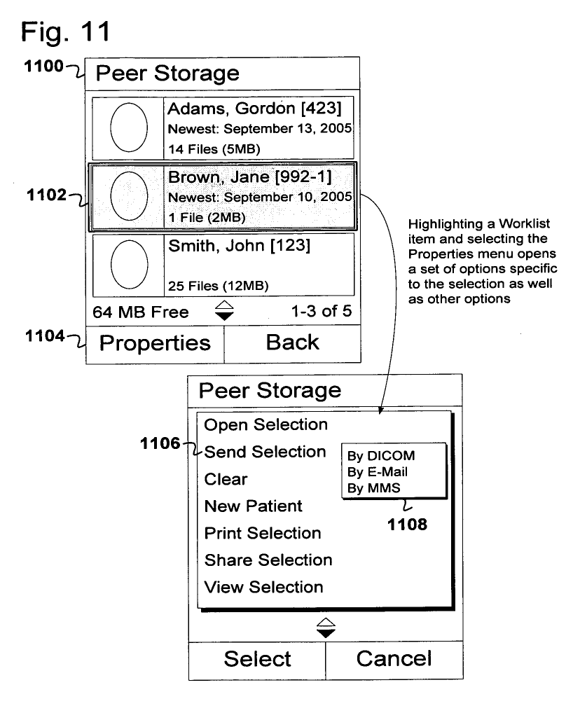

Thus, using the keys, buttons, joystick, jog-wheel and other navigation and selection tools that comprise the alphanumeric and QWERTY keypads of all smartphones, a user can initiate the activity of a wizard generated dialog between the user and his/her smartphone. For example, FIG. 11 illustrates an image of the UI storage screen (1100) which lists the information items stored on the user's smartphone and the use of this UI with its underlying cascade of additional user options that include Open Selection, Send Selection, Clear, etc. Referring to FIG. 11, if the user scrolls to and highlights an item of information on (1100), e.g., Jane Brown (1102) and then selects the menu function key on the smartphone keypad, the underlying menu of user options is presented. This menu allows the user to Open, Send, Clear, Print, Share or View the selected item with more finely detailed levels of user options becoming available when one of the menu items is selected. For example, if the send command (1106) is selected, the user is prompted in a new sub-menu (1108) to select between the various send modes that are available including DICOM, E-Mail or MMS. In other embodiments of this invention, the healthcare worker uses a touch sensitive screen employed with some handheld and Tablet PCs, or the mouse and keyboard of a conventional PC, to make a similar series of menu based selections. As illustrated in FIG. 2 through 9 inclusively, these search and retrieval processes employ the DICOM Service Classes including, but not limited to, Storage, Verification, Modality Worklist, and Query/Retrieve, all of which are defined in the DICOM 3.0 Standard. Similar search and receive processes can be made by way of the HL7 standard.

It is important to point out that, while the disclosures made in this document are directed mainly at the medical industry, it will be recognized by skilled software and smartphone engineers that similar timely alerting processes can be equally important in other professional fields, including business, law, engineering and so on, and that the disclosures made here are applicable to many other fields of human endeavor.

FIG. 1 illustrates and identifies the connectivity pathways used to realize the information transfers that are the subject of the invention. The application of these Internet based pathways and protocols are generally well known by software engineers and they are now widely employed by the general populace in Internet-connected, telephony-based, information transfer. In addition, it is generally well known to residents of the United States that the Health Insurance Portability and Accountability Act (HIPAA), signed into law by President Clinton on Aug. 21, 1996 (Pub. L. 104-191, 110 Stat. 1936) protects the privacy of personal medical information and mandates that personal medical information of all types be stored and transmitted in a secure manner so as to ensure the privacy and security of the healthcare information. Thus this invention employs a variety of security providing protocols that are also well known and generally employed in digital information transfer via the Internet and Internet-connected devices such as smartphones. These security provisions are also illustrated in FIG. 1.

FIG. 1 illustrates and identifies the secure wireless pathways employed by this invention to connect to central servers, such as PACS, with each element in the pathway having its own standardized implementation process. FIG. 2 illustrates the protocols used to effect information transfer over those pathways. It is important to note that, in the field of medicine, either hardware based security protocols provide the encryption and authorization layer between the remote and local devices or the DICOM Standard itself provides secure encryption of healthcare data and thus the security of DICOM encoded healthcare information. Therefore, since security provisions are resident in all protocols and devices described in this invention, all described communications between the smartphone device and the healthcare network are secure to at least and often exceeding the extent mandated by HIPAA and other laws bearing on the security of healthcare information. Likewise, this invention is designed to operate over complimentary smartphones services, known as Personal Area Networks (PAN), that use Bluetooth, a protocol developed by the Bluetooth Special Interest Group (SIG) for short-range wireless transmission. This protocol allows smartphones to communicate with other nearby Bluetooth equipped devices such as desktop computers, ear-pieces, printers and digital scanners without the use of connecting wires.

In the same way that there are standard procedures that govern computerized Internet data transmission (TCP/IP) and standard service protocols that govern wireless telephony (e.g. GSM), there are also a series of smartphone operating systems (OS's) that govern the execution of a series of digital instructions known as algorithms or software applications. Thus, the algorithms or software applications that comprise this invention reside mainly on a smartphone and are designed to be readily altered or modified so as to function seamlessly within the context of a variety of mobile phone OS's including, but not limited to, the Symbian OS, Palm OS, Windows Mobile 5.0 OS and the Java based OS's, such as the Research In Motion (RIM) Blackberry device. Finally, it is anticipated that, at some time (for example, when the healthcare worker is at their personal office or residence), the most expedient and convenient method of accessing information that is the subject of an alert notification may be via the healthcare worker's PC. Like smartphones, PC operation is governed by another series of popular OS's including the various versions of Windows, Apple Mac OS, or Linux. Consequently, the algorithms and processes provided by this invention are designed to operate under the latter named OS's and, in general, they can be readily recompiled or otherwise modified to operate under any known OS by a practitioner skilled in the art of software engineering.

1. A method comprising identifying a first data storage device that is configured to store medical information for a patient in a protocol format that complies with jurisdictional laws related to protection of privacy of said medical information; locating said medical information in said first data storage device; and directing said first data storage device to securely and automatically send said medical information to a second data storage device in a manner that complies with said jurisdictional laws.

2. The method of claim 1 wherein said protocol format is one of a Digital Imaging and Communication in Medicine (DICOM) protocol format; a Health Level 7 (HL7) protocol format; and a protocol format compliant with Health Insurance Portability and Accountability Act (HIPAA).

3. The method of claim 1 further comprising storing said medical information received from said first data storage device at said second data storage device.

4. The method of claim 3 wherein said storing includes storing said medical information at said second data storage device in said protocol format.

5. The method of claim 3 further comprising requiring said second data storage device to send to said first data storage device an acknowledgement of receipt and storage of said medical information and removing said medical information from storage in said first data storage device upon receipt of said acknowledgement from said second data storage device.

6. The method of claim 1 wherein said locating and said directing steps are performed in real-time.

7. The method of claim 1 further comprising providing an operation selection menu on said second data storage device and allowing a user of said second data storage device to perform said locating and directing steps using said operation selection menu.

8. The method of claim 1 wherein said second data storage device is operationally compliant with said protocol format and said first and said second data storage devices are configured to operatively recognize each other, wherein said method further comprises providing a third data storage device that is operationally compliant with said protocol format and configuring said third data storage device to perform said identifying, locating and directing steps.

9. The method of claim 8 further comprising providing a fourth data storage device that is operationally compliant with said protocol format and that is configured to operatively recognize said first data storage device and configuring said third data storage device to direct said first data storage device to securely and automatically send said medical information to said second and said fourth data storage devices.

10. The method of claim 8, wherein each of said first, second, and third data storage devices is one of a non-portable computing device configured to perform secure data communication in a manner that complies with said jurisdictional laws; a portable, wireless device configured to perform secure data communication in a manner that complies with said jurisdictional laws, wherein said portable, wireless device is one of cellular telephone, a smartphone, a Personal Digital Assistant (PDA), a Tablet PC (Personal Computer), a laptop computer capable of wireless communication, and a Blackberry® mobile communication device; and a server computer that is configured to perform secure data communication in a manner that complies with said jurisdictional laws, wherein said sever computer is one of a Picture Archiving and Communications Systems (PACS) server, a Radiology Information Systems (RIS) server, a Hospital Information Systems (HIS) server, a Cardiology Information System (CIS) a Laboratory Information System (LIS), a Magnetic Resonance (MR) imager, a Computerized Tomography (CT) Scanner, and an Electronic Medical Records (EMR) server.

11. The method of claim 1 further comprising storing said medical information received from said first data storage device at said second data storage device in said protocol format; providing a third data storage device that is operationally compliant with said protocol format, and wherein said first and said third data storage devices are configured to be operatively non-cognizant of each other, whereas each of said first and said third data storage devices is configured to operatively recognize said second data storage device; and transferring said medical information from said first data storage device to said third data storage device by configuring said second data storage device to securely and automatically send said medical information stored therein to said third data storage device.

12. The method of claim 1 wherein said second data storage device is operationally non-compliant with said protocol format, and wherein said directing step includes performing one of directing said first data storage device to securely and automatically send said medical information to said second data storage device using a MIME (Multipurpose Internet Mail Extension) encoded electronic mail; directing said first data storage device to securely and automatically send said medical information to said second data storage device as an MMS (Multimedia Messaging Service) message; and directing said first data storage device to securely and automatically send an electronic mail containing a non-encoded textual and pictorial representation of said medical information to said second data storage device.

13. The method of claim 1 further comprising providing a third data storage device that is operationally compliant with said protocol format; configuring said third data storage device to obtain location information for said medical information in said first data storage device; sending said location information to said second data storage device as an SMS (Short Message Service) message; and configuring said second data storage device to use said location information in said SMS message to direct said first data storage device to securely and automatically send said medical information to said second data storage device.

14. The method of claim 1 wherein said medical information includes one or more of a patient-specific record created for said patient; a test result for said patient; and a patient-specific report information for said patient.

15. The method of claim 1 wherein said locating includes locating said medical information in said first data storage device using communication signals generated under said protocol format.

16. The method of claim 1 further comprising establishing a communication link between said first and said second data storage devices via a secure data communication network, wherein said data communication network includes a cellular telephone network, the Internet, a secure Local Area Network (LAN), a Virtual Private Network (VPN), a Wireless Local Area Network (WLAN), a Wide Area Network (WAN), a Bluetooth-based Personal Area Network (PAN), and a broadband wireless access network based on Wi-Fi, WiMax or IrDa protocols, and performing said locating and directing steps over said data communication network.

17. A data communication device configured to execute a program code, which, upon execution, causes said device to identify a first data storage device that is configured to store medical information for a patient in a protocol format that complies with jurisdictional laws related to protection of privacy of said medical information; locate said medical information in said first data storage device; and direct said first data storage device to securely and automatically send said medical information to said data communication device in a manner that complies with said jurisdictional laws.

18. The data communication device of claim 17 wherein said program code, upon execution, causes said data communication device to further store said medical information received from said first data storage device in said protocol format; and securely transfer said medical information from said data communication device to a second data storage device that is operationally compliant with said protocol format, and wherein said first and said second data storage devices are configured to be operatively non-cognizant of each other, whereas each of said first and said second data storage devices is configured to operatively recognize said data communication device.

19. The data communication device of claim 17 wherein said program code, upon execution, causes said data communication device to further establish a communication link with said first data storage device via a secure data communication network, wherein said data communication network includes one or more of a cellular telephone network, the Internet, a secure Local Area Network (LAN), a Virtual Private Network (VPN), a Wireless Local Area Network (WLAN), a Wide Area Network (WAN), a Bluetooth-based Personal Area Network (PAN), and a broadband wireless access network based on Wi-Fi, WiMax or IrDa protocols.

20. The data communication device of claim 17 wherein said program code, upon execution, causes said data communication device to further securely and automatically send said medical information to a second data storage device using a MIME (Multipurpose Internet Mail Extension) encoded electronic mail, wherein said second data storage device is operationally non-compliant with said protocol format; securely and automatically send said medical information to said second data storage device as an MMS (Multimedia Message Service) message; or securely and automatically send an electronic mail containing a non-encoded textual and pictorial representation of said medical information to said second data storage device.

21. (canceled)

22. (canceled)

23. (canceled)

24. (canceled)

25. (canceled)

26. (canceled)

27. (canceled)
